(19) United States
(12) Patent Application Publication
(10) Pub. No.: US 2015/0124074 A1
(43) Pub. Date: May 7, 2015

(54) IMAGE ACQUISITION APPARATUS AND IMAGE ACQUISITION METHOD

(71) Applicant: CANON KABUSHIKI KAISHA, Tokyo (JP)

(72) Inventor: Yui Sakuma, Utsunomiya-shi (JP)

(21) Appl. No.: 14/532,964

(22) Filed: Nov. 4, 2014

(30) Foreign Application Priority Data
Nov. 7, 2013 (JP) 2013-231578

(51) Int. Cl. G02B 21/36

(52) U.S. Cl. CPC G02B 21/365; G02B 21/361; G02B 21/362
USPC 348/79

(57) ABSTRACT

An image acquisition apparatus includes first and second imaging elements, an image formation optical system, a subject stage that supports a subject, and a control unit. The image formation optical system forms an image of the subject on light-receiving surfaces of the first and second imaging elements. The control unit acquires imaging results by imaging a correction mark disposed on the subject stage while changing a relative position between the first imaging element and the correction mark in an optical axis direction of the image formation optical system. The control unit moves, in accordance with the imaging results, the first imaging element or subject stage in the optical axis direction so the first imaging element and the correction mark are conjugate, acquires an imaging result by imaging the correction mark, and moves, in accordance with the acquired imaging result, the second imaging element in the optical axis direction.

### BACKGROUND OF THE INVENTION

1. Field of the Invention

The present invention relates to an image acquisition apparatus in which a microscope and the like is used, and relates also to an image acquisition method.

2. Description of the Related Art

Recently, in the field of the pathological diagnosis, the clinical study and the like, a virtual slide system which improves efficiency in data management and telediagnosis by acquiring, as a digital image, a microscope image of pathological specimen, such as tissue pieces extracted from a human body, is attracting attention. The pathological specimen which is a subject of this system is a prepared specimen fabricated by disposing, between slide glass and cover glass, a tissue piece that is thinly sliced into about several μm to about tens of μm, and fixing the tissue piece by a sealing agent.

Since high resolution is required for an objective lens of a microscope for pathology observation, a depth of field of the lens may become shallower by setting to a higher NA side. The depth of field of the objective lens typically used in the microscope for pathology observation is about 0.5 to 1.0 μm which is narrower than a thickness of a tissue piece. Therefore, in order to acquire an image of the tissue piece across the entire thickness thereof, it is necessary to image the tissue piece stepwise by, for example, imaging repeatedly while changing a relative position between a focal point of the objective lens and the subject in an optical axis direction.

Under these circumstances, there has been a demand for shortening imaging time of a subject in the optical axis direction by imaging a plurality of different positions of the subject in the optical axis direction at the same time.

As a means to satisfy the demand, Japanese Patent Laid-Open No. 2011-209488 proposes an image acquisition apparatus in which a light flux splitting element is provided near a conjugate image of a pupil of an objective lens to split light flux from a specimen into two or more light beams, and in which a position variable imaging element of which focusing position can be changed in an optical axis direction is provided. With this configuration, a plurality of different positions in the optical axis direction can be imaged at the same time.

Japanese Patent Laid-Open No. 2011-081211 includes an optical path branching unit for branching light which has passed through an image formation optical system into two optical paths and for forming an image on an imaging element which has two imaging areas. Therefore, a degree of focusing with respect to a subject is detected from the imaged images. Since the positions of the subject in the optical axis direction can be detected by using a plurality of images imaged at the same time, a processing speed for acquiring the image of the subject can be increased.

However, in an image acquisition apparatus including a plurality of imaging elements, each of the focusing positions of a plurality of imaging elements may be changed due to deformation of an optical element or a support portion thereof caused by temporal changes, such as a temperature change in an ambient environment. Therefore, there has been a problem that, since the focusing position of each imaging element is changed, a relative position among a plurality of focusing positions in the optical axis direction may be changed. When the relative position is changed, since the position at which imaging is actually performed differs from a position that has been assumed, there is a possibility that an image out of focus may be acquired or that the acquired image becomes insufficient.

In both Japanese Patent Laid-Open No. 2011-209488 and Japanese Patent Laid-Open No. 2011-081211, since the change in the relative position among a plurality of focusing positions in the optical axis direction is not considered, positional accuracy of each focusing position in image acquisition is decreased.

### SUMMARY OF THE INVENTION

An image acquisition apparatus as an aspect of the present invention includes a first imaging element, a second imaging element, an image formation optical system configured to form an image of a subject on light-receiving surfaces of the first and second imaging elements, a subject stage configured to support the subject, and a control unit, wherein the control unit controls to acquire a plurality of imaging results by imaging, by the first imaging element, a correction mark disposed on the subject stage while changing a relative position between the first imaging element and the correction mark in an optical axis direction of the image formation optical system, move, in accordance with the plurality of imaging results of the first imaging element, the first imaging element or the subject stage in the optical axis direction so that the first imaging element and the correction mark are conjugate, acquire an imaging result by imaging the correction mark by the second imaging element, and move, in accordance with the imaging result of the second imaging element, the second imaging element in the optical axis direction.

Further aspects of the present invention will become apparent from the following description of exemplary embodiments with reference to the attached drawings.

### BRIEF DESCRIPTION OF THE DRAWINGS

FIG. 1 is a schematic diagram illustrating a configuration of an image acquisition apparatus of a first embodiment.

FIG. 2 is a flowchart illustrating an image acquisition method using the image acquisition apparatus of the first embodiment.

FIG. 3 is a flowchart illustrating a method for correcting a relative position among a plurality of focusing positions using a correction mark provided in a subject in the image acquisition apparatus of the first embodiment.

FIG. 4 is a flowchart illustrating a method for correcting the relative position among a plurality of focusing positions using a correction mark provided in a subject stage in the image acquisition apparatus of the first embodiment.

FIG. 5A is a schematic diagram illustrating a method for generating data for correction in the image acquisition apparatus of the first embodiment.

FIG. 5B is a schematic diagram illustrating a method for acquiring an amount of change in the relative position among a plurality of focusing positions in an optical axis direction in the image acquisition apparatus of the first embodiment.

FIG. 5C is a schematic diagram illustrating a state in which the relative position among a plurality of focusing positions has been corrected in the image acquisition apparatus of the first embodiment.

FIG. 6 is a schematic diagram illustrating a configuration of an image acquisition apparatus of a second embodiment.

### DESCRIPTION OF THE EMBODIMENTS

### First Embodiment

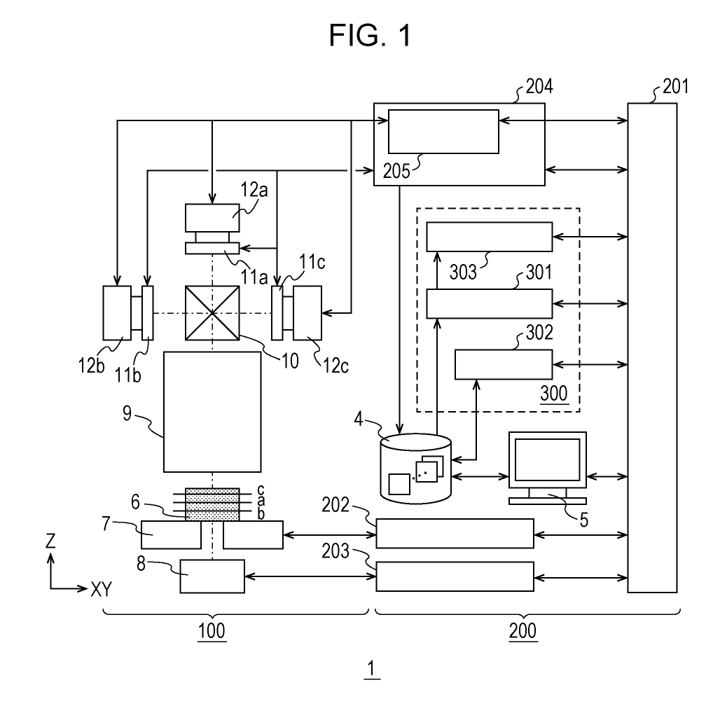

A configuration of an image acquisition apparatus (hereafter, referred to as an “apparatus 1”) of the present embodiment will be described with reference to FIG. 1. FIG. 1 is a schematic diagram illustrating the configuration of the apparatus 1. The apparatus 1 includes an imaging apparatus 100, a control unit 200, a processing unit 300, a storage unit 4 and a display unit 5.

The imaging apparatus 100 is an apparatus for imaging a subject 6. Examples of the imaging apparatus 100 include a digital microscope and a virtual slide scanner.

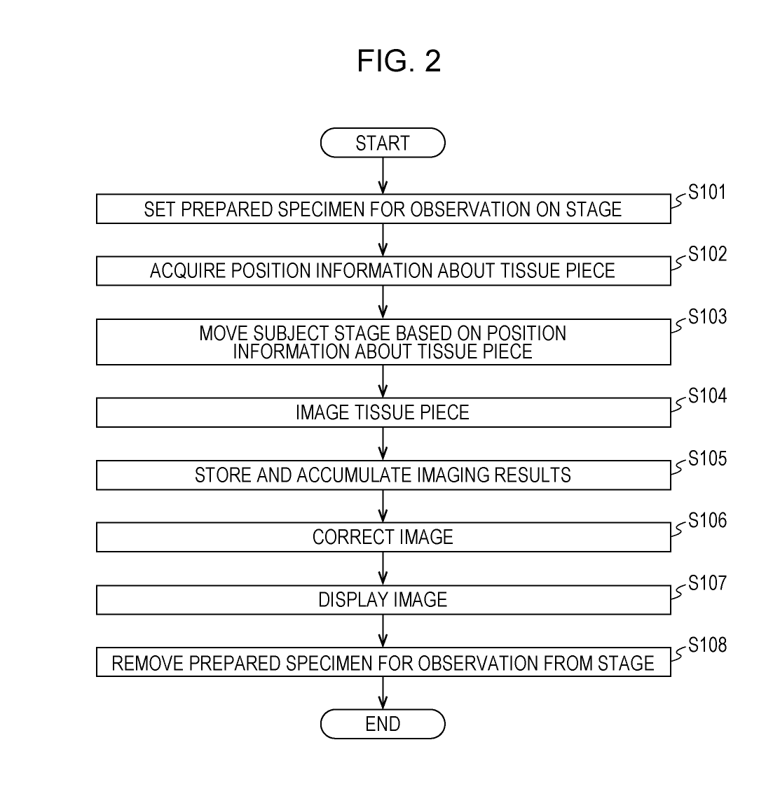

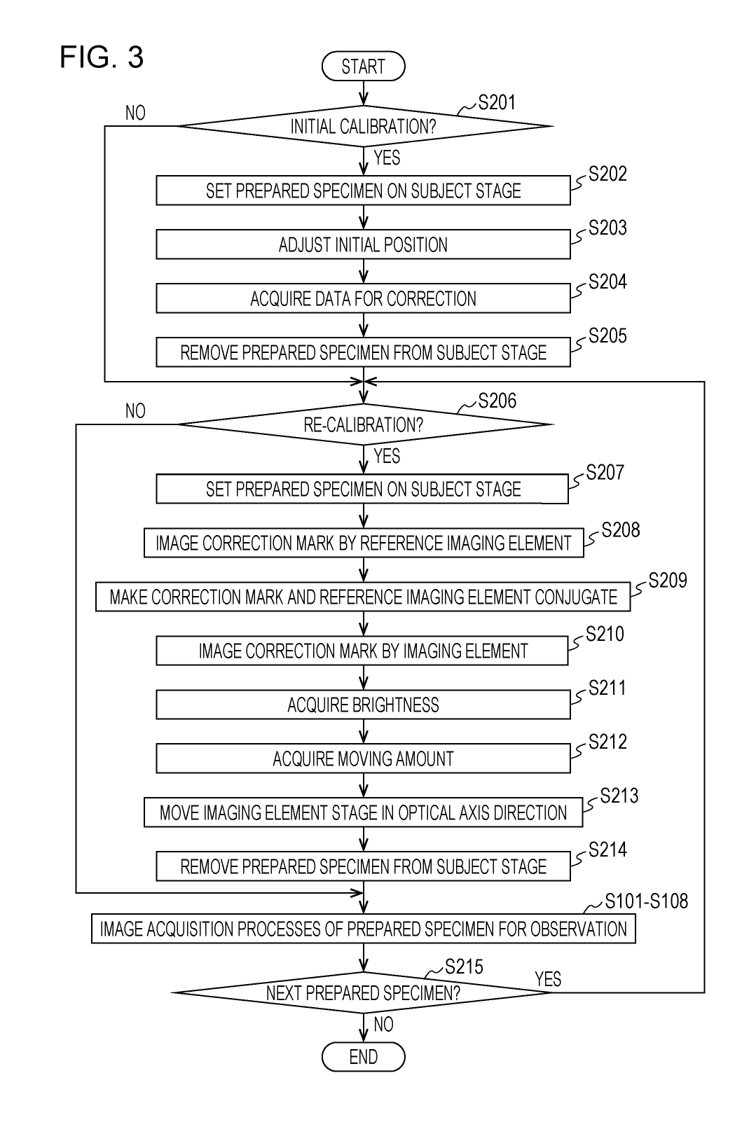

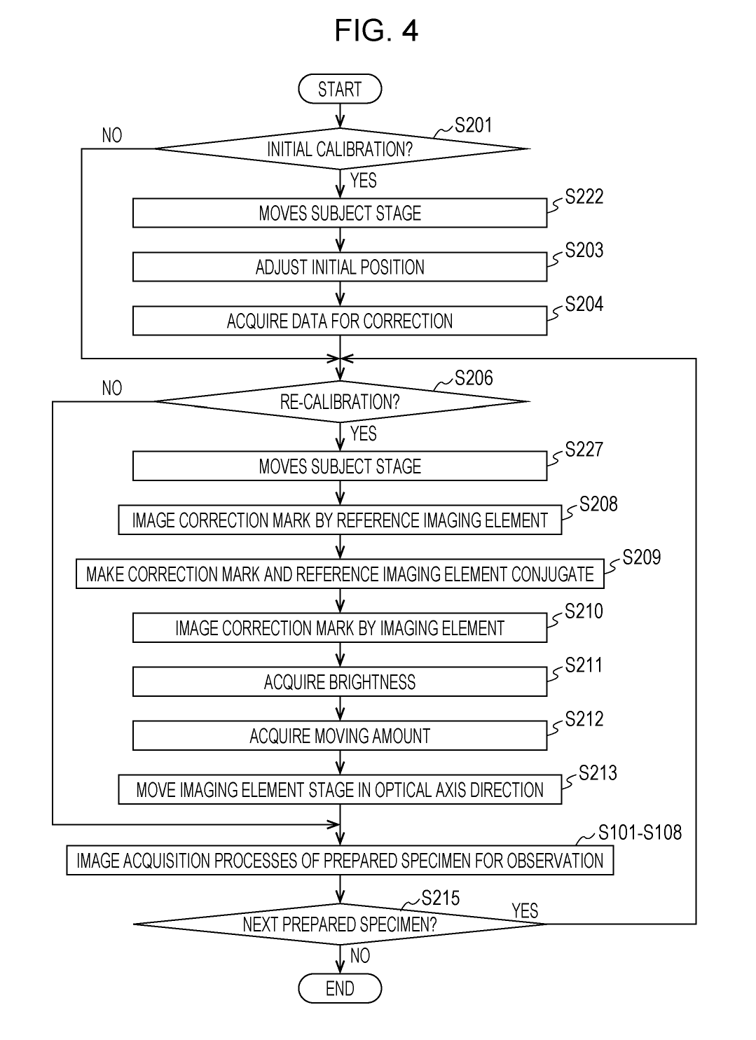

The control unit 200 controls various kinds of processes of the entire apparatus 1. In particular, the control unit 200 is a computer provided with a CPU, a memory, a storage device and the like and is connected to the imaging apparatus 100. Programs corresponding to respective steps S101 to S108 illustrated in FIG. 2 and steps in FIGS. 3 and 4 are stored in the memory of the control unit 200. The CPU performs each process by reading and executing the programs and controls the apparatus 1.

The processing unit 300 is a unit which corrects images imaged in the imaging apparatus 100 and performs arithmetic operations and is incorporated in the computer as a dedicated processing board. The storage unit 4 is a unit which stores and accumulates images imaged in the imaging apparatus 100. Examples of the storage unit 4 include an external storage apparatus, such as hard disk. The display unit 5 is a display device which displays the acquired images for viewing.

The imaging apparatus 100 includes a subject stage (hereafter, referred to as a “stage 7”), an illuminating unit 8, an objective lens 9, a light flux splitting element (hereafter, referred to as an “element 10”), imaging elements 11a, 11b and 11c (hereafter, referred to as “elements 11a, 11b and 11c”), imaging element stages 12a, 12b and 12c (hereafter, referred to as “stages 12a, 12b and 12c”). In this specification, as illustrated in FIG. 1, a direction which perpendicularly crosses an optical axis direction of the objective lens 9 is referred to as an XY direction and the optical axis direction of the objective lens 9 is referred to as a Z direction.

The stage 7 is a stage which supports the subject 6. When the stage 7 is moved, the position of the subject 6 is changed in the XY direction and in the Z direction. As the stage 7, an electromotive driving mechanism using ball screws, piezoelectricity and the like, is used in the present embodiment.

The illuminating unit 8 is a device which includes a light source and an optical system to illuminate the subject 6. As the light source, a halogen lamp, a light emitting diode (LED) and the like, are used in the present embodiment.

The light from the illuminating unit 8 passes through the subject 6 and then forms an image on each of light-receiving surfaces of the elements 11a, 11b and 11c by an image formation optical system which includes the objective lens 9 and the element 10. That is, the image formation optical system is an optical system which splits light from the objective lens 9 into a plurality of light beams at the element 10, and forms an image of the subject 6 on each of the light-receiving surfaces of the elements 11a, 11b and 11c. As the element 10, an optical element, such as a half mirror and a prism, is used in the present embodiment.

Although the light is split on an image surface side of the objective lens 9 in FIG. 1, the light may be split on, for example, a pupil plane of the objective lens 9. In that case, it is necessary to provide the optical element, such as the image formation lens, between the element 10 and the elements 11a, 11b and 11c.

The elements 11a, 11b and 11c photoelectrically convert the received light and output image data of the subject 6 as electrical signals. As the elements 11a, 11b and 11c, an image sensor, such as a charge coupled device (CCD) and a complementary metal-oxide semiconductor (CMOS), is used in the present embodiment. The imaging apparatus 100 of the present embodiment includes three elements 11a, 11b and 11c.

The stages 12a, 12b and 12c are stages which support the elements 11a, 11b and 11c, respectively, and move the positions of corresponding elements 11a, 11b and 11c in the optical axis direction of the image formation optical system or a direction perpendicularly crossing the optical axis direction of the image formation optical system. The stages 12a, 12b and 12c are manual or electric stages and in which a driving mechanism using ball screws, piezoelectricity and the like is used in the present embodiment. In the present embodiment, the stages 12a, 12b and 12c are provided to correspond to the elements 11a, 11b and 11c, respectively.

The “optical axis direction of the image formation optical system” in this specification refers to a direction parallel to the optical axis of the image formation optical system (i.e., a coaxial optical system). In particular, the optical axis direction of the image formation optical system of the subject 6 and the stage 7 is the Z direction and the optical axis direction of the image formation optical system of the element 11a and the stage 12a is also the Z direction. However, in the present embodiment, since the optical axis is diffracted at the element 10, the optical axis direction of the image formation optical system of the elements 11b and 11c and the stages 12b and 12c is the XY direction. The optical axis direction of the image formation optical system may be simply referred to an “optical axis direction.”

In the imaging apparatus 100, each light flux split at the element 10 is arranged to form an image on the light-receiving surface of each of the elements 11a, 11b and 11c. A plurality of elements 11a, 11b and 11c are arranged so that optical path lengths between the imaging elements 11a, 11b, 11c and the subject 6, and optical path lengths between the imaging elements 11a, 11b, 11c and the stage 7 differ from one another. With this configuration, a plurality of different positions in the optical axis direction in the subject 6 (i.e., a, b and c) can be imaged at the same time.

As described before, an example of the subject 6 of which digital image is to be acquired in the apparatus 1 is a prepared specimen for observation for pathological diagnosis in which cells and tissue pieces are enclosed. Usually, a tissue piece observed for pathological diagnosis is thinly sliced into about several μm to about tens of μm, fixed by a sealing agent and covered with cover glass. Since high resolution is required for the objective lens 9 by which a tissue piece is observed in an enlarged manner, the objective lens 9 is designed to have a high NA and a depth of field of about 0.5 to 1 μm, which is narrow for a thickness of the tissue piece. Therefore, in order to acquire an image of the tissue piece across the entire thickness thereof, it is necessary to image the tissue piece at a plurality of positions in a thickness direction, i.e., the Z direction.

As a method therefor, there is a method for imaging the tissue piece across the entire thickness while stepwisely moving the stage 7 which fixes the subject 6 in the Z direction by an amount equivalent to the depth of field of the objective lens 9. However, there is a problem that imaging takes time because the stage 7 needs to be moved stepwise a plurality of times in the Z direction.

It is also necessary to acquire position information about the tissue piece enclosed in the prepared specimen for observation in advance. However, since a difference in refractive index between the tissue piece and the sealing agent is small, it is difficult to use a distance measurement sensor and the like for detecting a position by using the difference in the refractive index. Then, a method for specifying the position of the tissue piece based on the differences in the contrast, the brightness and the like between a dyed tissue piece and the sealing agent in the imaging result of the subject 6 is used. However, this method also takes long imaging time because it is necessary to repeat stepwise moving and imaging with respect to the sealing agent which has the thickness of about 100 μm.

Considering these problems, a configuration in which the focusing positions of a plurality of elements 11a, 11b and 11c differ from one another as in the case of the imaging apparatus 100 can image a plurality of different positions in the optical axis direction at the same time. It is desirable that the distance between each of the focusing positions a, b and c of the elements 11a, 11b and 11c in the optical axis direction is set to be equivalent to or shorter than the depth of field of the objective lens 9. The focusing position here refers to an optically conjugate position with the elements 11a, 11b and 11c (specifically, the image pickup surface) via the image formation optical system.

The control unit 200 includes a main body control unit 201 (hereafter, referred to as a “control unit 201”), a subject stage control unit 202 (hereafter, referred to as a “control unit 202”), an illumination control unit 203 (hereafter, referred to as a “control unit 203”) and an imaging element control unit 204 (hereafter, referred to as a “control unit 204”). The control unit 201 is a unit which controls each control unit of the apparatus 1 in an integrated manner. Driving timing and the like of each control unit are controlled by the control unit 201.

The control unit 202 controls to move the stage 7 in the XY direction and in the Z direction and performs position control of the stage 7. The control unit 203 controls the entire illuminating unit 8, such as ON/OFF control of a light source of the illuminating unit 8, control of a diaphragm, and conversion of a color filter.

The control unit 204 has a function to perform ON/OFF control about exposure of the elements 11a, 11b and 11c and to transmit electrical signals about the imaging results of the subject 6 output from the elements 11a, 11b and 11c to the storage unit 4. The control unit 204 includes a control unit 205. The control unit 205 is a unit which controls the movement of the stages 12a, 12b and 12c. In particular, the control unit 205 controls to move the stages 12a, 12b and 12c in the optical axis direction of the image formation optical system, i.e., in a direction perpendicularly crossing the light-receiving surface of each elements 11a, 11b and 11c.

The processing unit 300 includes an information acquisition unit 301, an image correction unit 302 and a moving amount acquisition unit 303.

The information acquisition unit 301 acquires information about the imaging results imaged in the imaging apparatus 100. The information about the imaging results refers to, for example, an evaluation value of contrast and brightness of the image of the subject. The relative position among a plurality of focusing positions and position information about a tissue piece can be acquired using the information about the imaging results. In the present embodiment, a variance of brightness with respect to a pixel of interest in the image is acquired as the information about the imaging result. The information about the imaging result, however, is not limited to the same: for example, a differential value of the image based on the Brenner function may be obtained and used as the information about the imaging result.

The information acquisition unit 301 specifies the position of the tissue piece enclosed in the prepared specimen for observation as the subject 6 from the information about the imaging results of the subject 6 imaged by the elements 11a, 11b and 11c, and performs acquisition of the position information about the tissue piece. In particular, the information acquisition unit 301 acquires the position information about the tissue piece by specifying the position of the tissue piece based on the differences in the contrast, the brightness and the like between a dyed tissue piece and the sealing agent.

The image correction unit 302 corrects the image as the imaging result imaged in the imaging apparatus 100. The correction may include color tone correction, gamma correction and noise processing based on acquired spectral transmittance.

The moving amount acquisition unit 303 acquires an amount of change in the relative position among each of the focusing positions a, b and c of the elements 11a, 11b and 11c in the optical axis direction. The acquired amount of change is used as the moving amount in which the stages 12a, 12b and 12c are moved in the optical axis direction in order to correct the relative position among the focusing positions a, b and c of each elements 11a, 11b and 11c by moving the stages 12a, 12b and 12c. The moving amount is acquired in accordance with the information about the imaging result acquired by the information acquisition unit 301 and in accordance with the data for correction acquired in advance.

The data for correction is data which indicates a relationship between the relative position among the elements 11a, 11b and 11c and the correction mark in the optical axis direction and the imaging result acquired by imaging the correction mark by the elements 11a, 11b and 11c.

Details of the method for acquiring the position information about the tissue piece enclosed in the prepared specimen in the information acquisition unit 301 and the method for acquiring the moving amount in the moving amount acquisition unit 303 will be described later.

An image acquisition process of the apparatus 1 of the present embodiment will be described with reference to FIG. 2. FIG. 2 is a flowchart illustrating the image acquisition method by the apparatus 1.

First, the prepared specimen for observation as the subject 6 is disposed on the stage 7 in step S101 of FIG. 2. In this case, a mechanism for automatically feeding, into the stage 7, a prepared specimen for observation from a cassette in which a plurality of prepared specimens for observation are stocked may be provided, or a user may dispose the prepared specimen for observation manually.

Then, the information acquisition unit 301 detects the position of the tissue piece enclosed in the prepared specimen for observation in the XY direction and in the Z direction, and acquires the position information about the tissue piece (S102).

Since the field of view of the used objective lens 9 is generally narrower than an area in which the tissue piece exists in the XY direction on the prepared specimen for observation, the position information of the tissue piece in the XY direction is acquired, the subject 6 is divided into a plurality of areas based on the acquired position information and then the subject 6 is imaged. Regarding the Z direction, similarly, it is only necessary that only areas in which the tissue piece exists are imaged. The process of setting a plurality of divided areas based on the acquired position information about the tissue piece is necessary, and the operation therefor is also performed in step S102. Therefore, since the imaging area can be set only to the area in which the tissue piece exists, data and imaging time that are unnecessary can be reduced.

As a method for acquiring the position information about the tissue piece, as described before, there may be a method for specifying the position of the tissue piece based on the differences in the contrast, the brightness and the like between a dyed tissue piece and the sealing agent by acquiring information about the imaging result from the imaging result imaged in the imaging apparatus 100.

First, as a method for detecting the position of the tissue piece in the XY direction, for example, a low magnification lens and a camera (not illustrated) are prepared and used to acquire information about an imaging result, and the position is specified using the acquired information about the imaging result. As a method for detecting the position of the tissue piece in the Z direction, first, position control of the stage 7 in the XY direction is performed so that an area of the tissue piece to be imaged exists in the field of view of the objective lens 9. At this time, position control of the stage 7 may be performed in accordance with the divided area which has been set based on the area, in the XY direction, in which the tissue piece exists acquired in advance.

Here, the position control of each of a plurality of elements 11a, 11b and 11c may be performed using the stages 12a, 12b and 12c. For example, position control may be performed to the elements 11a, 11b and 11c in the perpendicularly crossing direction or in the horizontal direction with respect to the light-receiving surface of each of the elements 11a, 11b and 11c. Therefore, the distance among the focusing positions a, b and c equivalent to each of a plurality of elements 11a, 11b and 11c can be changed arbitrarily and the time needed for the position detection can be shortened.

Each of the imaging results of the elements 11a, 11b and 11c is transmitted to the storage unit 4 via the control unit 204 and is stored and accumulated temporarily. The plurality of accumulated imaging results are transmitted to the information acquisition unit 301 and, as described before, the area in which the tissue piece exists in the Z direction is calculated based on the information about differences of the contrast, the brightness, and the like.

In step S103, the position control of the subject 6 is performed by the control unit 202 which controls to move the stage 7 based on the acquired position information about the tissue piece. The stage 7 is moved so that the tissue piece exists within each area of the focusing positions a, b and c of a plurality of elements 11a, 11b and 11c.

In step S104, the tissue piece is imaged at different positions in the optical axis direction by the elements 11a, 11b and 11c. In a case in which a Z-stack image of the tissue piece is to be acquired, it is desirable to set the distance among a plurality of focusing positions a, b and c in the Z direction to be equivalent to or shorter than the depth of field of the objective lens 9. In a case in which the tissue piece across the entire thickness is not able to be imaged in one imaging event, it is necessary to return to step S103 where the stage 7 is moved in the optical axis direction again, and imaging is repeated in step S104.

The images imaged by the elements 11a, 11b and 11c are transmitted to the storage unit 4, and are stored and accumulated in step S105. The images which have stored and accumulated are then corrected and processed in the image correction unit 302 (S106), and transmitted to the display unit 5 in step S107 for display, viewing and the like.

The prepared specimen for observation after being imaged is removed from the stage 7 in step S108. The image acquisition process by the apparatus 1 has been described above.

Next, a method for correcting the relative position among a plurality of focal points by the apparatus 1 will be described. FIG. 3 is a flowchart illustrating the method for correcting the relative position among a plurality of focal points by the apparatus 1.

First, a main power of the apparatus 1 is turned ON and the entire apparatus is started. Next, in step S201, it is determined whether initial calibration is necessary about the relative position among the focusing positions of the elements 11a, 11b and 11c in the optical axis direction. This step may be omitted when the initial calibration is unnecessary in a case in which, for example, the relative position among a plurality of focusing positions is already adjusted, the number of samples of the subject 6 to be observed is small, and the like. Omission of step S201 may be determined by the user or by the control unit 201 and the like.

In a case in which the initial calibration is not performed, the process proceeds to the image acquisition process of the prepared specimen for observation of steps S101 to S108 described before. In a case in which the initial calibration is performed, in step S202, a subject, such as a prepared specimen, in which a correction mark is provided is first disposed on the stage 7, and the correction mark is disposed within the field of view of the objective lens 9.

The correction mark is a mark used in the initial calibration and re-calibration described later for adjusting the focusing position of each of the elements 11a, 11b and 11c. In the present embodiment, a test chart for correcting the focusing position, such as line and space, is used as the member for correction. As the correction mark, a correction mark may be provided in the prepared specimen or the like to prepare a member for correction dedicated for calibration or, alternatively, a correction mark may be provided at a part of an area in which the tissue piece is not enclosed in the prepared specimen for observation in which the tissue piece and the like is enclosed. It is desirable that the correction mark can be imaged with as high resolution as possible in order to correct the relative position among a plurality of focusing positions highly accurately.

Further, instead of using a subject in which a correction mark is provided, a pinhole, a slit and the like may be provided as a correction mark in an area of the stage 7 different from the area in which the subject 6 is supported. A flowchart in that case is illustrated in FIG. 4. In that case, setting and removal of the prepared specimen in steps S202, S205, S207 and S214 of FIG. 3 become unnecessary. Instead, moving the stage 7 in the XY direction so that the correction mark exists within the field of view of the objective lens 9 as in steps S222 and S227 of FIG. 4 is performed. At the time of replacement of the subject 6, the stage 7 needs to be moved to a predetermined position in the XY direction so that the subject 6 does not interfere with the objective lens 9. The position of the correction mark may be determined so as to exist within the field of view of the objective lens 9 when the stage 7 is moved to the predetermined position in the XY direction. Therefore, calibration can be performed in parallel with the replacement of the subject 6, whereby the throughput can be improved.

Examples of the correction mark disposed on the stage 7 may include a mark having varying depth in color so that an amount of change in the relative position among a plurality of focal points in the Z direction can be calculated. For example, a concentric circular mark may be used.

Next, in step S203, the control unit 202 and the control unit 205 adjust the initial position of the distance of a plurality of focusing positions a, b and c, in the optical axis direction, equivalent to each of the imaging elements 11a, 11b and 11c. Here, as an example, a distance between the focusing position a and the focusing position b and a distance between the focusing position a and the focusing position c are adjusted distances equivalent to the depth of field of the objective lens 9 and are set to be an initial position.

First, the control unit 202 moves the stage 7 in the optical axis direction so that the correction mark disposed on the stage 7 and the element 11c are conjugate, that is, the focusing position c corresponds to the correction mark.

Next, the control unit 202 moves the stage 7 stepwise in the optical axis direction by an amount equivalent to the depth of field and performs position adjustment of the element 11a so that the element 11a and the correction mark are conjugate at that position. Regarding the element 11b, by repeating the same operation, a plurality of focusing positions can be adjusted to the initial positions. After the adjustment, with respect to the focusing position a of the reference element 11a (i.e., the first imaging element), the relative position of the focusing positions b and c of the remaining elements 11b and 11c (i.e., the second imaging element) in the Z direction is transmitted to the information acquisition unit 303 as information about the initial position.

Next, in step S204, in accordance with the brightness of the imaging result of the correction mark imaged by a plurality of elements 11a, 11b and 11c, data for correction among a plurality of focal points is generated in the information acquisition unit 301. The data for correction is an evaluation function generated by acquiring brightness from the imaging result of a plurality of elements 11a, 11b and 11c and interpolating the brightness, and is a curve of which axes are the relative position and the brightness. The data for correction is not limited to the evaluation function but may be a table of a relationship between the relative positions and information about the imaging results.

The data for correction is generated based on the focusing position of any one of a plurality of elements 11a, 11b and 11c. In the present embodiment, the focusing position a of the element 11a is used as a reference. The data for correction generated in step S204 is used during the re-calibration described later.

Finally, the prepared specimen for correction is removed from the stage 7 in step S205. Then the initial calibration is completed.

Next, in step S206, it is determined whether re-calibration is necessary about correction of the relative position among a plurality of focusing positions equivalent to each of a plurality of elements 11a, 11b and 11c in the optical axis direction. Whether re-calibration is necessary or not is determined in the control unit 201 or the like based on, for example, elapsed time after the apparatus is started, the sample number of the subject 6 for which the image acquisition process is performed, ambient environment, and temperature information in the apparatus. Alternatively, tendency of change in the focusing positions in the optical axis direction may be studied in advance and the timing of re-calibration may be determined in accordance with the tendency.

In a case in which re-calibration is unnecessary, the process proceeds to the image acquisition process of the prepared specimen for observation in steps S101 to S108. Since re-calibration is unnecessary immediately after the initial calibration is performed, in such a case, step S206 may be omitted and the process may directly be proceed to step S101.

In a case in which re-calibration is performed, the prepared specimen in which the correction mark used during the initial calibration is first disposed on the stage 7 in step S207. Next, the correction mark is imaged by the element 11a while changing the relative position between the element 11a which is the reference imaging element and the correction mark in the optical axis direction by the control unit 202 or the control unit 205 (S208).

Then, in accordance with a plurality of acquired imaging results, the control unit 202 moves the stage 7 in the optical axis direction so that the correction mark and the element 11a are conjugate (S209).

Next, the correction mark is imaged by the element 11b and the element 11c in a state in which the element 11a and the correction mark are conjugate (S210). The imaging results are transmitted to the information acquisition unit 301 where brightness in a specific pixel of each image imaged by the elements 11b and 11c is obtained (S211).

Next, in step S212, the moving amount acquisition unit 303 obtains the moving amounts of the relative positions of the focusing positions b and c of the elements 11b and 11c with respect to the focusing position a in accordance with the acquired brightness and data for correction. Although details of the method for acquiring the moving amount will be described later, it is necessary to acquire the brightness based on the element 11a which has been used as a reference when the data for correction is generated in step S204. The relative positions of the remaining focusing positions b and c with respect to the reference focusing position a in the optical axis direction is obtained from the acquired brightness and the data for correction. Information about each of the acquired relative positions is transmitted to the moving amount acquisition unit 303.

The moving amount acquisition unit 303 acquires the amount of change in the relative positions of the focusing positions b and c with respect to the reference focusing position a in the optical axis direction using the relative position information transmitted immediately before and the information about the initial position transmitted in step S203. The acquired amount of change is used as the moving amount for adjusting the positions of the elements 11b and 11c. Details of the method for acquiring the amount of change (i.e., the moving amount) will be described later.

In accordance with the acquired moving amount, the control unit 205 moves the stages 12b and 12c which support the elements 11b and 11c in the optical axis direction and the focusing positions b and c are corrected.

In step S214, the prepared specimen is removed from the stage 7 and the re-calibration is completed. After the re-calibration, the process proceeds to steps S101 to S108 and the image acquisition process of the prepared specimen for observation is executed.

After execution of steps S101 to S108, it is determined whether a subsequent subject 6 exists in step S215. In a case in which a subsequent subject 6 exists, the process proceeds to step S206 again and determines whether re-calibration is needed. In a case in which no subsequent subject 6 exists, the main power of the apparatus 1 is turned OFF and the entire apparatus is turned OFF. The method for correcting the relative position among a plurality of focusing positions by the apparatus 1 of the present embodiment has been described.

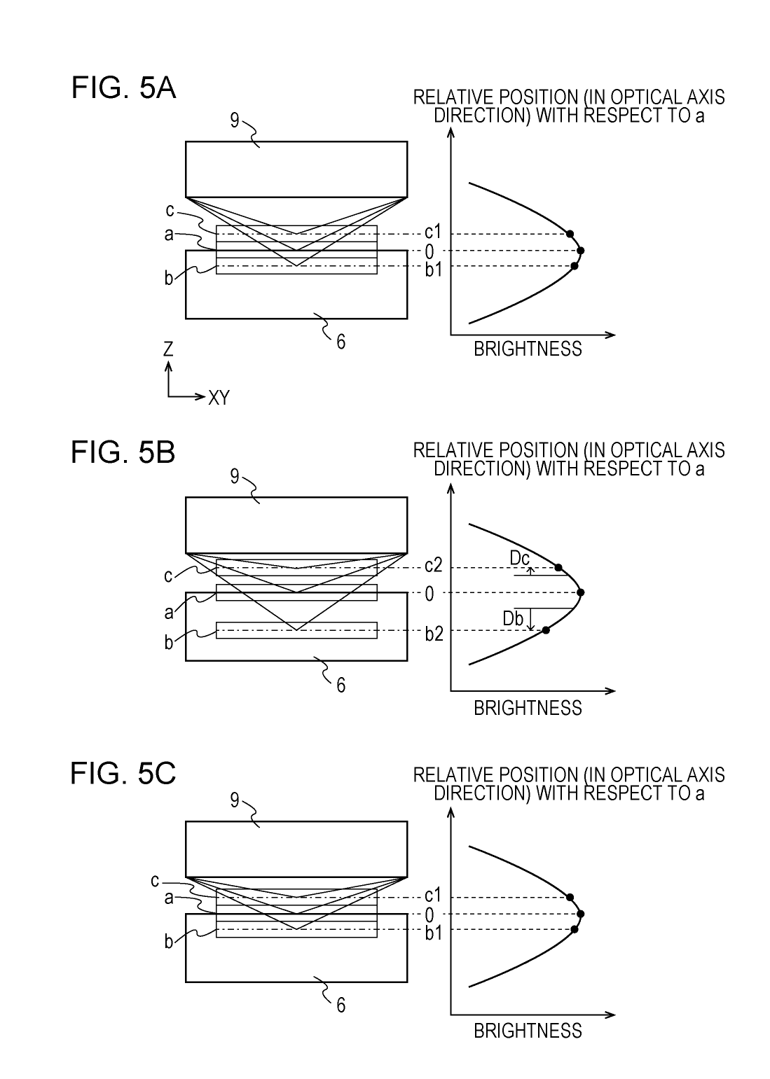

Next, details of the method for correcting the relative position among a plurality of focal points by the apparatus 1 will be described. FIGS. 5A to 5C are schematic diagrams illustrating the method for correcting the relative position among a plurality of focusing positions by the apparatus 1.

FIG. 5A is a schematic diagram illustrating a method for generating data for correction during initial calibration. FIG. 5B is a schematic diagram illustrating a method for acquiring the amount of change in the relative position in the optical axis direction among a plurality of focusing positions corresponding to a plurality of elements 11a, 11b and 11c during the re-calibration. FIG. 5C is a schematic diagram illustrating a state in which the relative position among a plurality of focusing positions has been corrected in accordance with the amount of change in the acquired relative position during the re-calibration.

The graphs of FIGS. 5A to 5C represent evaluation functions in which brightness is plotted on the horizontal axis and the relative position with respect to the focusing position a in the Z direction is plotted on the vertical axis.

First, a method for generating data for correction during the initial calibration will be described with reference to FIG. 5A. The data for correction is generated based on the focusing position a of the element 11a as a reference. First, the stage 7 is moved in the Z direction so that the correction mark disposed on the stage 7 and the element 11a are conjugate.

As a method for adjusting the position, the information acquisition unit 301 generates an evaluation function in accordance with the brightness of a pixel of interest in the image imaged by a plurality of elements 11a, 11b and 11c. Next, a position at which the value of the generated evaluation function becomes the maximum is calculated and the calculated position is set to a focusing position with respect to the correction mark. Then the stage 7 is moved in the Z direction so that the calculated position is within the range of the focusing position a.

Although the focusing position as the reference is set to the central position a in FIGS. 5A to 5C, other focusing positions b and c may also be used. Although the position of the stage 7 is controlled in the optical axis direction to be focused with the correction mark at the focusing position a which is used as a reference, the positions of a plurality of elements 11a, 11b and 11c may be controlled using the stages 12a, 12b and 12c.

Next, after making the correction mark and the element 11a be conjugate, an evaluation function as the data for correction is generated from a plurality of imaging results acquired by imaging the correction mark by the elements 11b and 11c. Since the position is controlled so that the correction mark and the first imaging element are conjugate, the brightness in the evaluation function becomes the maximum value at the focusing position a.

In the graph of the evaluation function in FIG. 5A, the position of the focusing position a is set to 0, the relative position of the focusing position b with respect to the focusing position a is set to b1, and the position of the focusing position c with respect to the focusing position a is set to c1. When the distance among the focusing positions is set to be equivalent to the depth of field during the initial calibration, the following expression holds: |b1|=|c1|.

It is also possible that the element 11a and the correction mark are not made to be conjugate and that the data for correction is generated based on another position as a reference. At this time, the brightness does not necessarily become the maximum at the focusing position a. In this case, there may be a problem during the re-calibration that alignment becomes difficult due to adhesion of, for example, dust to the correction mark when the relative position between the element 11a and the correction mark in the optical axis direction is made to be the same as that during the initial calibration. It is also expected that the relative position between the stage 7 and the element 11a is moved due to thermal expansion of the stage 7. Therefore, it is desirable to generate the data for correction in a state in which the element 11a and the correction mark are conjugate.

Next, with reference to FIG. 5B, a method for acquiring the amounts of change in the relative positions of the focusing positions b and c with respect to the reference focusing position a during the re-calibration will be described. First, the position of the stage 7 is moved in the same manner as in the initial calibration so that the correction mark and the element 11a are conjugate.

Next, the correction mark is imaged by the elements 11b and 11c in a state in which the element 11a and the correction mark are conjugate. Regarding the acquired image, brightness with respect to a pixel of interest is acquired by the information acquisition unit 301 in the same manner as in the initial calibration.

Each acquired brightness is plotted on the evaluation function of the data for correction generated during the initial calibration. Then the relative positions b2 and c2 of the focusing positions b and c with respect to the reference focusing position a in the optical axis direction are acquired.

The acquired relative positions b2 and c2 are transmitted to the moving amount acquisition unit 303. The transmitted relative position information b2 and c2 and the information b1 and c1 about the initial positions transmitted in step S203 exist in the moving amount acquisition unit 303. Therefore, the amounts of change b2−b1 and c2−c1 of the relative positions of the remaining focusing positions b and c in the Z direction with respect to the reference focusing position a can be obtained.

FIG. 5C illustrates a state in which the positions of the elements 11b and 11c have been corrected by the stages 12b and 12c in accordance with the moving amount using the acquired amounts of change b2−b1 and c2−c1 as the moving amount. With the configuration of the present embodiment, the relative position among a plurality of focusing positions in the optical axis direction can be acquired and the relative position can be corrected in accordance with the acquired relative position.

The method for acquiring the amount of changes in the relative positions of the focusing positions b and c with respect to the reference focusing position a during the re-calibration is not limited to that described above. For example, in accordance with the amount of change in the relative position, division images of the tissue piece across the entire thickness thereof may be acquired while changing the position of the stage 7 in the optical axis direction or stepwisely changing the moving amount.

Although it is assumed that the tissue piece across the entire thickness thereof is divided into areas equivalent to the depth of field of the objective lens 9 in the present embodiment, this is not restrictive. For example, only a part of the thickness of the tissue piece may be imaged.

For example, the acquired division images of the tissue piece across the entire thickness thereof may be composed to generate a single depth-enlarged image.

As described above, in the present embodiment, if the relative position between the element 11a and the correction mark is adjusted so that the element 11a and the correction mark are conjugate, the moving amounts of the stages 12a, 12b and 12c for adjusting the positions of the elements 11b and 11c can be acquired. Therefore, the relative position among the focusing positions of a plurality of imaging elements in the optical axis direction of the image formation optical system in the image acquisition apparatus which includes a plurality of imaging elements can be corrected. Further, re-calibration can be performed at a high speed, whereby throughput of the apparatus 1 can be improved.

### Second Embodiment

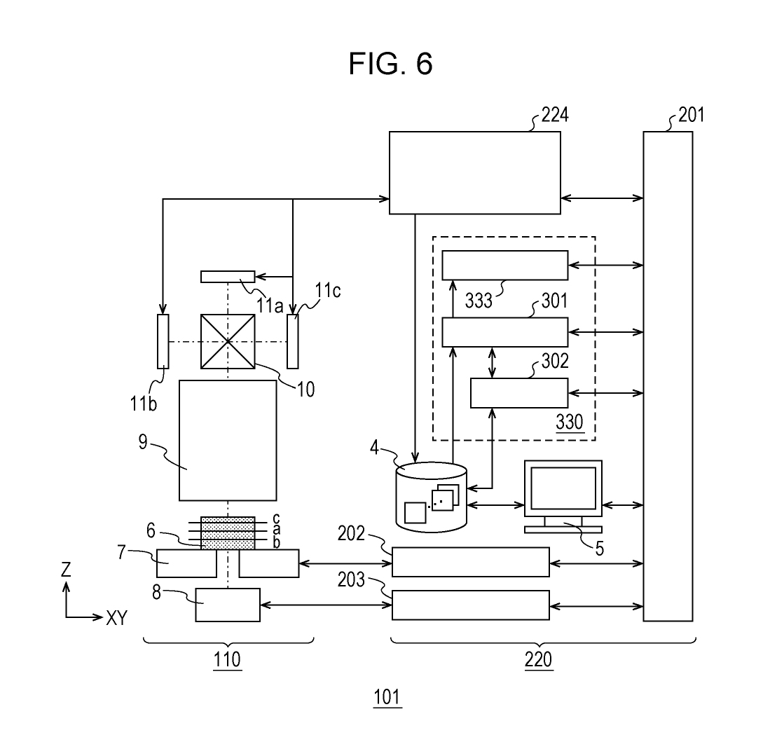

An image acquisition apparatus 101 (hereafter, referred to as an “apparatus 101”) of a second embodiment will be described with reference to FIG. 6. FIG. 6 is a schematic diagram illustrating a configuration of the apparatus 101.

In the apparatus 101, an imaging apparatus 110 does not include stages 12a, 12b and 12c as compared with the apparatus 1 of the first embodiment. Therefore, a control unit 224 of a control unit 220 includes no control unit 205.

A processing unit 330 of the present embodiment includes an information acquisition unit 301, an image correction unit 302 and a correction amount acquisition unit 333. Although the information is transmitted to the moving amount acquisition unit 303 from the information acquisition unit 301 in the first embodiment, data is transmitted bidirectionally between the information acquisition unit 301 and the correction amount acquisition unit 333 in the present embodiment.

In the present embodiment, the correction amount acquisition unit 333 acquires a correction amount based on information about imaging results, such as brightness acquired in the information acquisition unit 301. Data transmission is performed also between the information acquisition unit 301 and the image correction unit 302 in order to correct an image in the image correction unit 302 in accordance with the acquired correction amount.

In the first embodiment, the relative position is corrected by moving the stages 12a, 12b and 12c in accordance with the amount of change in the relative position among a plurality of focusing positions in the optical axis direction. In the present embodiment, in contrast, restoration of the image equivalent to the initial position is performed by image correction.

The correcting method will be described. In the first embodiment, the amounts of change b2−b1 and c2−c1 of the relative position of the focusing positions b and c with respect to the reference focusing position a in the optical axis direction are acquired by the moving amount acquisition unit 303 in step S212 of FIG. 3. The acquired amounts of change are used as the moving amounts of the stages 12b and 12c. In the present embodiment, the correction amount acquisition unit 333 acquires the amounts of change b2−b1 and c2−c1 and the acquired amounts of change are transmitted to the information acquisition unit 301. The process about the re-calibration is completed in the present embodiment here.

Next, the process proceeds to step S101 of FIG. 2 and an image acquisition process of a prepared specimen for observation is started. In step S102 in the image acquisition process, the subject 6 is imaged in order to acquire position information about a tissue piece enclosed in the prepared specimen for observation. The imaging results are transmitted to the information acquisition unit 301.

The information acquisition unit 301 acquires brightness of an arbitrary pixel for each of a plurality of pieces of image data which are the imaging results. In that process, the information acquisition unit 301 generates position information in accordance with the amount of change in the relative position transmitted from the correction amount acquisition unit 303. In this manner, accurate position information from which the change in the relative position among a plurality of focusing positions of the imaging element has been excluded can be acquired.

In step S104, the tissue piece is imaged in accordance with the acquired position information. The image acquired by imaging is transmitted to the information acquisition unit 301 and the image correction unit 302 via a storage unit 4.

Subsequently, the image correction unit 302 corrects the transmitted image (S106). In the present embodiment, the relative position among a plurality of focusing positions is corrected in this step. In particular, a low pass filter of which shape is determined by the amounts of change b2−b1 and c2−c1 as the correction amount acquired by the correction amount acquisition unit 333 is used for the image and, thereby, changes in the image resulting from a misalignment of the relative position of the focusing position are corrected. If the point spread function (PSF) indicating the characteristics of the image formation optical system used during the imaging is used as the low pass filter, more precise correction can be expected.

Therefore, the relative position among the focusing positions of a plurality of imaging elements in the optical axis direction of the image formation optical system in the image acquisition apparatus which includes a plurality of imaging elements can be corrected. Since the image equivalent to the initial position can be restored by correcting the image, the relative position among a plurality of focusing positions in the Z direction can be corrected without providing stages 12a, 12b and 12c which move the elements 11a, 11b and 11c.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

For example, although the light which has passed through the subject 6 is split into three directions by the element 10 in the embodiment described above, this is not restrictive. For example, it is only necessary to determine the number of light flux splitting elements and the imaging elements depending on the number of divisions.

Further, although the data for correction is generated using the imaging results imaged by using a plurality of elements 11a, 11b and 11c in the embodiment described above, this is not restrictive. The data for correction may be generated based on a plurality of imaging results acquired by selecting an arbitrary imaging element and imaging the correction mark while changing the relative position between the imaging element and the correction mark in the optical axis direction. In a case in which the data for correction has been acquired in advance, step S204 may be omitted.

Further, the stages 12a, 12b and 12c for moving the elements 11a, 11b and 11c are not provided in the apparatus 101 of the second embodiment. Even in such an image acquisition apparatus, since it is not necessary to move the stages 12a, 12b and 12c, advantageous effects of shortening the time needed for the acquisition of an image are exhibited.

This application claims the benefit of Japanese Patent Application No. 2013-231578, filed Nov. 7, 2013 which is hereby incorporated by reference herein in its entirety.

What is claimed is:

1. An image acquisition apparatus, comprising:
a first imaging element;
a second imaging element;
an image formation optical system configured to form an image of a subject on light-receiving surfaces of the first and second imaging elements;
a subject stage configured to support the subject; and
a control unit, wherein the control unit controls to acquire a plurality of imaging results by imaging, by the first imaging element, a correction mark disposed on the subject stage while changing a relative position between the first imaging element and the correction mark in an optical axis direction of the image formation optical system,
move, in accordance with the plurality of imaging results of the first imaging element, the first imaging element or the subject stage in the optical axis direction so that the first imaging element and the correction mark are conjugate,
acquire an imaging result by imaging the correction mark by the second imaging element, and
move, in accordance with the imaging result of the second imaging element, the second imaging element in the optical axis direction.

2. The image acquisition apparatus according to claim 1, further comprising a second imaging element stage configured to support the second imaging element,
wherein the control unit controls to move the second imaging element stage in the optical axis direction in accordance with the imaging result of the second imaging element and data for correction acquired in advance, and
wherein the data for correction is data indicating a relationship between a relative position of the second imaging element and the correction mark in the optical axis direction and an imaging result acquired by imaging the correction mark by the second imaging element.

3. The image acquisition apparatus according to claim 2, further comprising a second imaging element stage configured to support the second imaging element, wherein the control unit includes:
an information acquisition unit configured to acquire information about the imaging result acquired by imaging the correction mark by the second imaging element,
a moving amount acquisition unit configured to acquire a moving amount of the second imaging element stage moved in the optical axis direction in accordance with the information and the data for correction, and
an imaging element stage control unit configured to move the second imaging element stage in the optical axis direction in accordance with the moving amount.

4. The image acquisition apparatus according to claim 1, wherein the control unit controls to move the subject stage in the optical axis direction in accordance with the plurality of imaging results of the first imaging element so that the first imaging element and the correction mark are conjugate.

5. The image acquisition apparatus according to claim 1, wherein the control unit controls to acquire the image of the subject by imaging the subject by at least one of the first and second imaging elements.

6. The image acquisition apparatus according to claim 1, wherein the correction mark is disposed on the subject which is supported by the subject stage.

7. The image acquisition apparatus according to claim 1, wherein the correction mark is disposed in an area of the subject stage that is different from an area in which the subject is supported.

8. The image acquisition apparatus according to claim 1, wherein the correction mark is disposed in a member for correction which is supported on the subject stage instead of the subject.

9. An image acquisition apparatus, comprising:
a first imaging element;
a second imaging element;
an image formation optical system configured to form an image of a subject on light-receiving surfaces of the first and second imaging elements;
a subject stage configured to support the subject; and
a control unit, wherein the control unit controls to
acquire a plurality of imaging results by imaging, by the first imaging element, a correction mark disposed on the subject stage while changing a relative position between the first imaging element and the correction mark in an optical axis direction of the image formation optical system,
move, in accordance with the plurality of imaging results of the first imaging element, the first imaging element or the subject stage in the optical axis direction so that the first imaging element and the correction mark are conjugate,
acquire an imaging result by imaging the correction mark by the second imaging element, and
correct an image of the subject imaged by the second imaging element in accordance with the imaging result of the second imaging element.

10. The image acquisition apparatus according to claim 9,
wherein the control unit controls to correct the image of the subject imaged by the second imaging element in accordance with the imaging result of the second imaging element and data for correction acquired in advance, and
wherein the data for correction is data indicating a relationship between a relative position of the second imaging element and the correction mark in the optical axis direction and an imaging result acquired by imaging the correction mark by the second imaging element.

11. The image acquisition apparatus according to claim 10, wherein the control unit includes:
an information acquisition unit configured to acquire information about the imaging result acquired by imaging the correction mark by the second imaging element,
a correction amount acquisition unit configured to acquire a correction amount of the image of the subject imaged by the second imaging element in accordance with the information and the data for correction, and
an image correction unit configured to correct, in accordance with the correction amount, the image of the subject photographed by the second imaging element.

12. The image acquisition apparatus according to claim 9, wherein the control unit controls to move the subject stage in the optical axis direction in accordance with the plurality of imaging results of the first imaging element so that the first imaging element and the correction mark are conjugate.

13. The image acquisition apparatus according to claim 9, wherein the control unit controls to acquire the image of the subject by imaging the subject by at least one of the first and second imaging elements.

14. The image acquisition apparatus according to claim 9, wherein the correction mark is disposed on the subject which is supported by the subject stage.

15. The image acquisition apparatus according to claim 9, wherein the correction mark is disposed in an area of the subject stage different from an area in which the subject is supported.

16. The image acquisition apparatus according to claim 9, wherein the correction mark is disposed in a member for correction which is supported on the subject stage instead of the subject.

17. An image acquisition method for an image acquisition apparatus having a first imaging element, a second imaging element, an image formation optical system configured to form an image of a subject on light-receiving surfaces of the first and second imaging elements, a subject stage configured to support the subject, and a control unit, the image acquisition method comprising:
acquiring a plurality of imaging results by imaging, by the first imaging element, a correction mark disposed on the subject stage while changing a relative position between the first imaging element and the correction mark in an optical axis direction of the image formation optical system;
moving, in accordance with the plurality of imaging results of the first imaging element, the first imaging element or the subject stage in the optical axis direction so that the first imaging element and the correction mark are conjugate;
acquiring an imaging result by imaging the correction mark by the second imaging element; and
moving, in accordance with the imaging result of the second imaging element, the second imaging element in the optical axis direction.

18. The image acquisition method according to claim 17, further comprising photographing the image of the subject by at least one of the first and second imaging elements.

19. An image acquisition method for an image acquisition apparatus having a first imaging element, a second imaging element, an image formation optical system configured to form an image of a subject on light-receiving surfaces of the first and second imaging elements, a subject stage configured to support the subject, and a control unit, the image acquisition method comprising:
acquiring a plurality of imaging results by imaging, by the first imaging element, a correction mark disposed on the subject stage while changing a relative position between the first imaging element and the correction mark in an optical axis direction of the image formation optical system;
moving, in accordance with the plurality of imaging results of the first imaging element, the first imaging element or the subject stage in the optical axis direction so that the first imaging element and the correction mark are conjugate;
acquiring an imaging result by imaging the correction mark by the second imaging element; and
correcting an image of the subject imaged by the second imaging element in accordance with the imaging result of the second imaging element.

20. A computer-readable storage medium storing a program to cause an image acquisition apparatus to perform the image acquisition method according to claim 17.

21. A computer-readable storage medium storing a program to cause an image acquisition apparatus to perform the image acquisition method according to claim 19.
